(19) United States
(12) Patent Application Publication
(10) Pub. No.: US 2018/0040905 A1
(43) Pub. Date: Feb. 8, 2018

(54) TEXTURED FUEL CELL COMPONENTS FOR IMPROVED WATER MANAGEMENT

(71) Applicant: Ford Global Technologies, LLC, Dearborn, MI (US)

(72) Inventors: Daniel E. WILKOSZ, Saline, MI (US); Kerrie K. GATH, Pittsfield, MI (US); Mark Stephen RICKETTS, Windsor (CA)

(21) Appl. No.: 15/228,124

(22) Filed: Aug. 4, 2016

(51) Int. Cl. H01M 8/0256; B23K 26/352; C23F 1/14; B23K 26/00; H01M 8/04291; H01M 8/04223

(52) U.S. Cl. CPC H01M 8/0256; H01M 8/04291; H01M 8/04253; C23F 1/14; B23K 26/0084; B23K 26/352; H01M 2008/1095

(57) ABSTRACT

A fuel-cell stack including treated bipolar plates is disclosed, as well as methods of treatment. The bipolar plates may include an active region wherein a fuel-cell reaction is configured to occur and an inactive region configured to supply, collect, and remove fluids from the active region. The inactive region may include one or more exit vias defined by the bipolar plate and having an inner surface configured to contact fluids received from the active region. At least a portion of the inner surface may have a hydrophobic textured surface. The methods may include treating a metal inner surface of an exit via defined in an inactive region of a fuel-cell bipolar plate that is configured to contact fluids received from an active region of the fuel-cell bipolar plate. The treatment may include removing material to form a hydrophobic textured surface on at least a portion of the inner surface.

### TECHNICAL FIELD

The present disclosure relates to textured fuel cell components for improved water management, for example, water removal and ice prevention.

### BACKGROUND

Fuel cells, for example, hydrogen fuel cells, are one possible alternative energy source for powering vehicles. In general, fuel cells include a negative electrode (anode), an electrolyte, and a positive electrode (cathode). In a proton exchange membrane fuel cell (PEMFC), the electrolyte is a solid, proton-conducting membrane that is electrically insulating while allowing for protons to pass through. Typically, the fuel source, such as hydrogen, is introduced at the anode using flow field passages of the anode side of a bipolar platewhere it reacts with a catalyst and splits into electrons and protons. The protons travel through the electrolyte to the cathode side of the membrane and the electrons pass through the bipolar plate or through an external circuit to the cathode. At the cathode, oxygen in air introduced from the cathode side of a bipolar plate reacts with the electrons and the protons at another catalyst to form water. One or both of the catalysts are generally formed of a noble metal or a noble metal alloy, typically platinum or a platinum alloy. During operation of a fuel cell, various levels of water may be generated on and along the fuel cell stack components, such as along or within plate flow field channels or other plate features and fuel cell plate interfacing surfaces. Some fuel cell systems may include gas/air flow pressure drops or other system operation control practices in an attempt to manage/remove generated water from the fuel cell plates. However, residual moisture may condense from cell surfaces and/or collect, producing water deposits along fuel cell surfaces that can remain after stack shut down. If exposed to subzero degree Celsius ambient conditions, this residual moisture/water can form ice blockages to gas flow paths. Ice formation can be detrimental to stack component durability and operation efficiency, especially at start up.

### SUMMARY

In at least one embodiment, a fuel-cell bipolar plate is provided. The bipolar plate may include an active region wherein a fuel-cell reaction is configured to occur and an inactive region configured to supply, collect, and remove fluids from the active region. The inactive region may include one or more exit vias defined by the bipolar plate and having an inner surface configured to contact fluids received from the active region. At least a portion of the inner surface may have a hydrophobic textured surface.

In one embodiment, substantially the entire inner surface has the hydrophobic textured surface. The hydrophobic textured surface may include a plurality of cone-shaped surface features. In one embodiment, the surface features have a maximum width of less than 250 μm. In another embodiment, the surface features have a maximum width of 50 nm to 50 μm. The hydrophobic textured surface may have a contact angle with water of at least 100 degrees. The inactive region may further include a transition region defined by the bipolar plate and disposed between the active region and the one or more exit vias, the transition region including one or more channels or features configured to transport and guide fluids from the active region to the exit vias. At least a portion of the one or more channels or features in the transition region may include a hydrophobic textured surface. The hydrophobic textured surface may include a plurality of cone-shaped surface features having a maximum width of less than 250 μm. In one embodiment, a smallest dimension of the one or more exit vias is at most 0.50 mm.

In at least one embodiment, a method is provided. The method may include treating a metal inner surface of an exit via defined in an inactive region of a fuel-cell bipolar plate that is configured to contact fluids received from an active region of the fuel-cell bipolar plate. The treatment may include removing material to form a hydrophobic textured surface on at least a portion of the inner surface.

The treatment may form a plurality of cone-shaped surface features. In one embodiment, the treatment forms surface features having a maximum width of less than 250 μm. The surface features may have a maximum width of 50 nm to 50 μm. The treating step may include removing material from the metal inner surface using a laser treatment or using a chemical treatment. In one embodiment, the treatment is applied to the entire inner surface of the exit via. The method may include treating at least one metal channel surface of a transition region of the inactive region of the fuel-cell bipolar plate that is disposed between the exit via and the active region, the treatment forming a hydrophobic textured surface on at least a portion of the channel surface. The bipolar plate may include a plurality of air exit vias defined therein and the treating step may include treating a metal inner surface of each air exit via to form a hydrophobic textured surface on at least a portion of the inner surface.

In at least one embodiment, a fuel-cell bipolar plate is provided. The bipolar plate may include an active region and an inactive region configured to supply, collect, and remove fluids from the active region. The inactive region may include an exit via defined by the bipolar plate and having a width of at most 3.0 mm, and an inner surface of the exit via may be configured to contact fluids received from the active region. At least a portion of the inner surface may have a hydrophobic textured surface.

### BRIEF DESCRIPTION OF THE DRAWINGS

FIG. 1 is an exploded view of a proton exchange membrane fuel cell (PEMFC) unit cell, according to an embodiment;

FIG. 2 is a cross-section of a PEMFC showing the components of the anode, cathode, and proton exchange membrane, according to an embodiment;

FIG. 3 is a perspective view of a PEMFC bipolar plate, according to an embodiment;

FIG. 4 is a perspective view of another embodiment of a PEMFC bipolar plate; and

FIGS. 5A and 5B are schematic cross-section examples of hydrophobic textured surface patterns.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

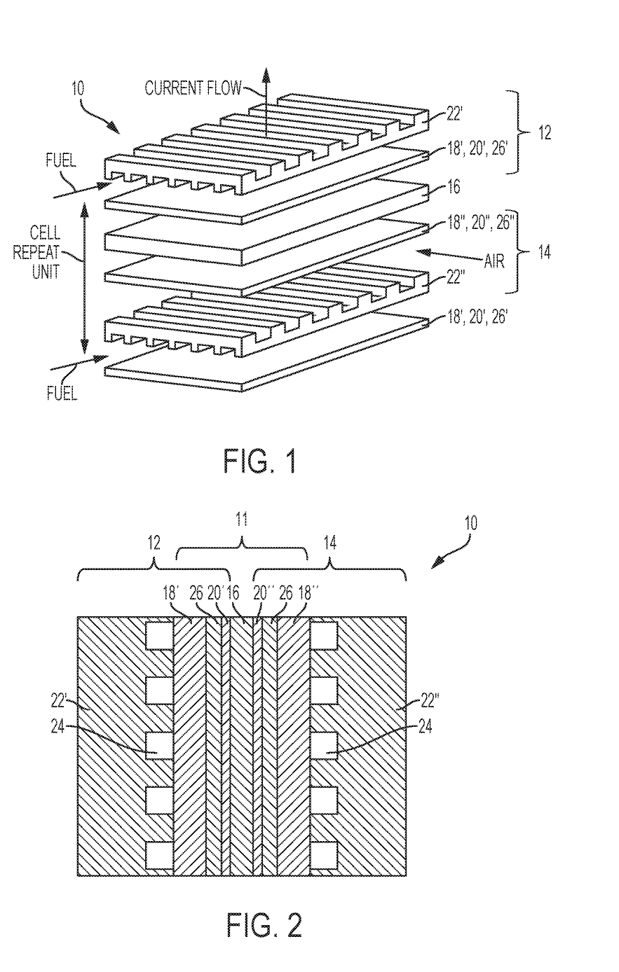

With reference to FIGS. 1 and 2, an example of a proton exchange membrane fuel cell (PEMFC) 10 unit cell is illustrated. The PEMFC 10 unit cell generally includes a negative electrode (anode plate) 22′ and a positive electrode (cathode plate) 22″, separated by a membrane electrode assembly (MEA) 11. As depicted in FIGS. 1 and 2, the MEA 11 can be made up of anode side 12 and cathode side 14 components, such as gas diffusion layers (GDL) 18′ and 18″ and catalyst layers 20′ and 20″ separated by a proton exchange membrane (PEM) 16 (also called a polymer electrolyte membrane). Anode 22′ and cathode 22″ plates generally possess channel geometries 24 used to distribute gases during operation. Catalyst layers 20′ and 20″ may be the same for both the anode side 12 and cathode side 14 of the MEA 11. Catalyst layers may also be different between the anode side 12 and cathode side 14 of the MEA 11. The catalyst layer 20′ may facilitate the splitting of hydrogen atoms into hydrogen ions and electrons while the catalyst layer 20″ facilitates the reaction of oxygen gas, hydrogen ions, and electrons to form water. In addition, the MEA 11 may include an anode side 26′ and cathode side 26″ microporous layer (MPL) disposed between respective GDL layers 18 and catalyst layers 20.

The PEM 16 may be any suitable PEM known in the art, such as a fluoropolymer, for example, Nafion (a sulfonated tetrafluoroethylene based fluoropolymer-copolymer). The GDL 18 may be formed of materials and by methods known in the art. For example, the GDL 18 may be formed from carbon fiber based paper and/or cloth. GDL materials are generally highly porous (having porosities of about 80%) to allow reactant gas transport to the catalyst layer (which generally has a thickness of about 8-15 μm), as well as liquid water transport from the catalyst layer. GDLs may be treated to be hydrophobic with a non-wetting polymer such as polytetrafluoroethylene (PTFE, commonly known by the trade name Teflon). A microporous layer (MPL) may be coated to the GDL side facing the catalyst layer to assist in water management during operation. The MPL may be formed of materials and by methods known in the art, for example, carbon powder and a binder (e.g., PTFE particles). The catalyst layer 20 may include a noble metal or a noble metal alloy, such as platinum or a platinum alloy. The catalyst layer may include a catalyst support, which may support or have deposited thereon a catalyst material.

The bipolar plates 22 may have channels 24 defined therein for carrying gases. The channels 24 may carry air or fuel (e.g., hydrogen). As shown in FIG. 1, the plates 22 and channels 24 may be rotated 90 degrees relative to each other. Alternatively, the plates 22 and channels may be oriented in the same direction or any combination thereof. The channels 24 need not be continuous or follow straight flow paths. Bipolar plate materials need to be electrically conductive and corrosion resistant under proton exchange membrane fuel cell (PEMFC) operating conditions to ensure that the bipolar plate performs its functions—feeding reactant gases to the membrane electrode assembly (MEA) and collecting current from the MEA.

As described in the Background, residual water may be present in conventional fuel cells despite system-level controls that attempt to remove or reduce it. Residual water can collect or puddle in or along various areas of a fuel cell plate, such as in channels, transition zones or manifold port openings and passages known as exit and inlet vias that can lead to and from port openings. Water collection in the vias may be exacerbated due to their small size or interaction with possible via geometry features which may result in water being drawn into the vias due to capillary action. Residual water present in a fuel cell is prone to freeze at ambient temperatures of 32° F. or below (depending on ambient pressure). Freezing of water within a fuel cell can cause component damage and may also act as a blockage to fuel and air at start-up. If ice blockages exist, they need to be removed or melted in order for a fuel cell to operate properly. Freeze start-up procedures may require the use of available fuel or stored energy and can introduce delay in being able to operate a fuel cell vehicle. Extended start-up times are also not generally desirable for customer usage. Freezing of the manifold vias (inlets and outlets) may be particularly problematic, since ice formation in the vias may cause a total blockage and prevent any gases upstream from flowing. Since vias can be the narrowest and/or shallowest portion of the gas flow path, a relatively small amount of residual water may result in restricted gas flow and or a large or complete blockage of gas flow.

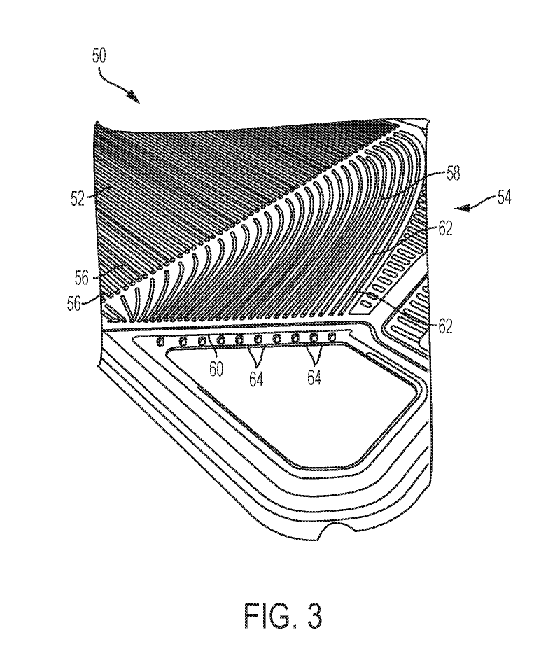

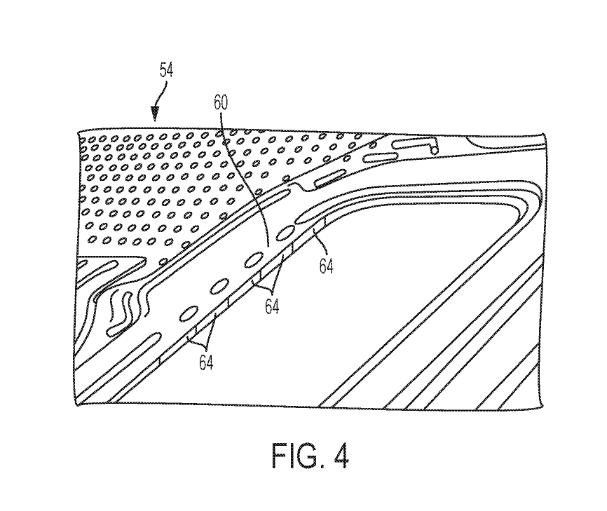

With reference to FIGS. 3-4, examples of a fuel cell bipolar plate 50 are shown. In general, the bipolar plate 50 may include an active area 52 and a non-active area 54. The active area 52 may be defined as the area of the bipolar plate where the reaction occurs between the hydrogen gas (or other fuel) and oxygen (e.g., air). The active area 52 may include one or more channels 56 that guide the fuel or the oxygen, depending on the side of the bipolar plate 50. The non-active area 54 may include the area of the bipolar plate where gas flow occurs but there are no reactions taking place. The non-active area may include channels, passages, or other geometry features such as pillars for management of gases (fuel and/or oxygen), coolants, or other substances. Water that is generated in the active area 52 may need to be removed through the channels or other features in the non-active area 54. In one embodiment, the non-active area 54 may include a transition area or zone 58 and an exit area or zone 60. The transition zone 58 may be disposed between the active area 52 and the exit zone 60.

The transition zone 58 may include one or more channels, passages 62, or other features, such as a reservoir, that receive a fluid from the active area 52. The fluid may be unreacted fuel or oxygen/air and may also include any water (or other liquids) formed during the fuel cell reaction. The transition zone 58 may collect the gases and any liquid from the active zone and guide or funnel it to the exit zone 60. While a bipolar plate 50 is shown and described having a transition zone 58, a transition zone 58 is not required and may not be present in other embodiments. The exit zone 60 may include one or more channels or passages 64 that receive a fluid from the active area 52 (optionally via a transition zone) and allow it to be removed from a stack of a plurality of bipolar plates 50. What happens to the fluid after it leaves the exit zone 60 may depend on the type of fluid (e.g., fuel or oxygen/air) and the design of the specific fuel cell. For example, if the fluid is unreacted fuel, it may be collected and recirculated. If the fluid is air/oxygen, it may be removed from the fuel cell stack and exhausted (e.g., to the environment). Water or other fluids may be collected and removed from the system (e.g., exhausted to the environment).

The channel passages 64 in the exit zone 60 may also be referred to as vias 64. Depending on operating conditions and plate flow field and transition zone design, vias 64 can be narrower or smaller in size than channels 56 in the active zone or channels 62 in the transition zone 58 (if present). Transition zones may also be void of channel features and use a type of pillar configuration instead. Via dimensions can also be larger than neighboring active zone or transition zone design cross sections. Vias are configured to help deliver desired gas flow pressures in conjunction with other plate features during operation of a fuel cell. In addition, vias are configured to help manage water removal from unit cells of a stack during operation and shut down. Regardless of dimension, vias need to address these two plate attributes during fuel cell operation. Making via surfaces hydrophobic can enhance stack operating pressure control and water management of fuel cell unit cells when using any size via. For comparison, an example PEM fuel cell can have a via width of 1.4 mm to 2.5 mm in compliance with an active flow field area channel width of 1.0 mm 0.40 mm. Via width is only one variable of comparison. Flow field channel, transition zone features and via geometries can also all have different depths.

The via depths may be the same depth or smaller than those of same plate flow field channel depths. For example, the via depth may be at least 10% less than the flow field channel depths, such as at least 25% or at least 50% less. In another embodiment, the via depth may be 10-50% less than the flow field channel depths. Therefore, as described above, smaller width or shallower depth vias may be more susceptible to the formation of ice blockages in cold weather. Accordingly, in at least one embodiment, steps may be taken to make the via 64 surfaces hydrophobic or super hydrophobic. A treatment may be performed on the vias 64 to make the surfaces thereof more hydrophobic. The treatment may be performed on the vias 64 alone, or the vias 64 and other portions of the bipolar plate 50. For example, the transition zone 58 may be treated, including the channels 62. The active area 52 may also be treated, including the channels 56. Hydrophobic treatment of these additional areas may further facilitate water removal and may assist in preventing freezing of the vias 64 and potential transition zone exit areas leading to the vias. However, in one embodiment, only the vias 64 may be treated, since they are generally the shallowest, narrowest, and/or highest risk area for freezing. In another embodiment, the channels 62 in the transition zone 58 and the vias 64 may be treated.

Any suitable treatment may be used to make the walls of the vias 64 hydrophobic (or increase their hydrophobicity). In at least one embodiment, the treatment may include altering the surface of the vias 64 directly (e.g., metal surface). This may mean that the hydrophobicity is not due to a coating being applied. In at least one embodiment, no coating is applied to the vias 64. However, in other embodiments, a hydrophobic coating may be applied to the vias 64. Coatings may wear off over time, while changing the structure of the via surface may be substantially permanent (at least over the lifetime of the fuel cell). Therefore, a treatment that alters the surface structure of the via walls may be more durable and longer-lasting. In one embodiment, the treated vias 64 may have a width of up to 3.0 mm, for example, no more than 2.5, 2.0, 1.5 or 1.0 mm. For example, the vias 64 may have a width of 0.5 to 3.0 mm, or any sub-range therein, such as 0.5 to 2.0 mm, 0.7 to 2.0 mm, 0.7 to 1.5 mm, or 0.8 to 1.2 mm. In another embodiment a smallest dimension (e.g., width or depth) of the treated vias 64 may be up to 1.0 mm, for example, no more than 0.75, 0.5, or 0.3 mm. For example, a smallest dimension (e.g., width or depth) of the treated vias 64 may be 0.1 to 0.7 mm, or any sub-range therein, such as 0.2 to 0.6 mm or 0.3 to 0.5 mm. However, these dimensions are not intended to be limiting, and the disclosed treatment may be applied to vias having larger or smaller dimensions.

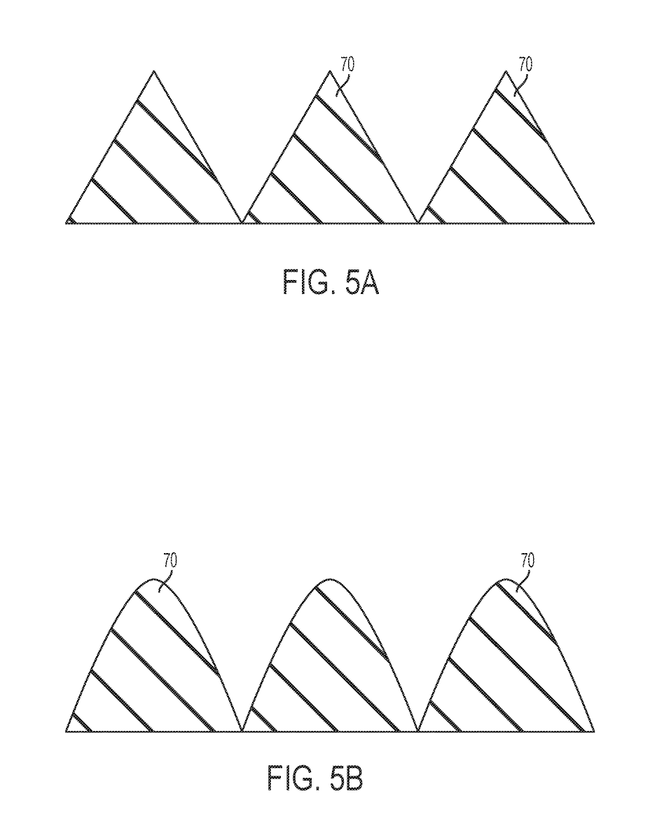

In at least one embodiment, the treatment may be a laser treatment. It has been found that a laser treatment may be used to render a metal (e.g., steel, Al, or Cu) surface hydrophobic. The laser treatment may be a femtosecond pulse laser treatment in which very short bursts of laser energy are used to alter the surface structure of a substrate. It is believed that the laser energy alters or changes the surface of the substrate through a combination of ablation and reformation. In one embodiment, the laser treatment may result in a plurality of surface features 70, which may be arranged in an array. As shown in cross-section in FIGS. 5A and 5B, example surface features 70 may be cone-shaped structures. The surface features 70 may have a rounded tip (e.g., FIG. 5B), or may be cylindrical structures having a tapered and possibly rounded tip. In another embodiment, the surface features 70 may be a tapered stepped structure, similar to a block pyramid, or other hydrophobic structures.

In at least one embodiment, the surface features 70 may be micro or nano features. Micro features may be those having a size (e.g., width or diameter) of less than 1 mm and nano features may be those having a size of less than 1 μm. In one embodiment, the surface features, such as cone-shaped or tapered cylinders, may have a width or diameter (e.g., at their largest point) of less than 500 μm, for example, less than 250 μm, 100 μm, 50 μm, 25 μm, 10 μm, 5 μm, or 1 μm. In another embodiment, the surface features may have a width or diameter (e.g., at their largest point) of 10 nm to 500 μm, or any sub-range therein, such as 10 nm to 100 μm, 50 nm to 50 μm, 100 nm to 10 μm, 500 nm to 10 μm, 1 μm to 25 μm, or others. By varying the parameters of the laser, the surface morphologies of the features may be controlled. In one example, surface hydrophobicity may be varied along a flow path or at certain geometric features by altering laser parameters such as laser power, speed, and line of sight. For example, by controlling one or more of the above parameters, a distal end of a via may be made more or less hydrophobic than a proximal end (e.g., adjacent the transition or active zone). The hydrophobicity may continuously change along the via length or there may be two or more different hydrophobicity regions.

The laser treatment may involve a layer-by-layer material removal (e.g., ablation) process. The pulsed laser beam may be scanned or rastered along the surface of the material to be treated (e.g., an inner wall of an exit via) to progressively generate the surface features. The surface to be treated may be scanned by the laser multiple times. There may be several factors or parameters that affect the creation of the surface features and the hydrophobicity of the resulting surface morphology. For example, the parameters may include the fluence of the laser (energy per area), the pitch of the laser scan (Δd, center-to-center distance), the scanning speed (v, e.g., mm/s), the number of layers (N, e.g., times the surface is scanned), or others. In general, it has been found that relatively greater scan speed and/or fluence may increase the hydrophobicity of the resulting morphology. Increasing the scan speed may result in a higher density of the surface features (e.g., cones). As the density increases, the size (e.g., diameter) of the surface features may be decreased. The surface features shown, for example in FIGS. 5A and 5B, may result in a hydrophobic coating having a contact angle with water of, for example, at least 90 or 100 degrees. The same laser treatment may also be used to make a metal surface more hydrophilic by adjusting the parameters above (e.g., in the opposite direction).

Accordingly, in at least one embodiment, the internal surfaces or walls of the vias 64 of the bipolar plate 50 may be at least partially treated using a laser treatment. For example, at least 50% of the internal surface area of at least one of the vias 64 may be laser treated, such as at least 60%, 70%, 80%, 90% or at least 99%. In another embodiment, the entire internal surface of at least one via 64 may be laser treated (e.g., 100%). One, some, or all of the vias 64 may be treated in this way. For example, at least 50% of the vias 64 may be treated as described above, such as at least 75% or at least 90% of the vias 64 (by number). In another embodiment, every via 64 may be laser treated. The above may apply to inlet vias, outlet (exit) vias, or all vias in the bipolar plate. Similarly, it may apply to the fuel vias (e.g., hydrogen), the oxygen (e.g., air) vias, or both.

In one embodiment, at least every outlet/exit via 64 is laser treated. The outlet vias may be substantially completely treated (e.g., at least 95% by area). In the embodiments described above, areas that are treated by the laser may be completely or substantially completely (e.g., at least 95%) covered by the surface features (e.g., cones or tapered cylinders). Therefore, the areas described above may also be percentages of the vias covered by the surface features. For example, if an outlet via is laser treated on 80% of its area, then the surface features may cover 80% of its area (e.g., the same area that was laser treated). While the treatment areas and percentages described above refer to the vias 64, they may also apply to the channels 62 of the transition zone 58 and/or the channels 56 of the active area 52.

In another embodiment, the treatment may be a chemical treatment, such as a chemical etching or chemical roughening treatment (referred to hereinafter as just a chemical treatment). The chemical treatment may produce surface features 70 having a similar structure and/or size to those describes above (e.g., cone-shaped, stepped pyramid, etc.). The chemical or chemicals used to treat the bipolar plate may depend on the bipolar plate composition. Non-limiting examples of bipolar plate materials may include aluminum, copper, and steel (e.g., stainless steel). The chemical treatment may include treating the bipolar plate with a strong acid or a strong base, such as HCl or NaOH, respectively (or any of the known 7 strong acids and 8 strong bases). The chemical treatment may include a single step or multiple steps. For example, it may include a first step with a first chemical and a second step with a second, different chemical. Additional steps and chemicals may also be included. Chemicals other than strong acids/bases may be included, such as ZnNO₃, Cu(NO₃)₂, AlCl₃, triethanolamine, La(NO₃)₃, FeCl₃, combinations thereof, or others.

In one embodiment, the chemical treatment may be performed by dipping at least a portion of the bipolar plate into a chemical bath. For example, only a portion including the vias, but not the transition or active zones may be dipped. In other embodiments, the vias and the transition zone may be dipped, but not the active zone. In another embodiment, the entire bipolar plate may be dipped in the chemical treatment. Methods other than dipping may also be used to apply the treatment. For example, the chemical treatment may be sprayed onto the bipolar plate. If the bipolar plate is formed in two halves, the inner surfaces may be sprayed before assembling the plate. The chemical treatment may also be an electrochemical treatment. Masking may be used to shield portions of the bipolar plate from the treatment. In some embodiments, the inner and outer surfaces of the vias may be treated (e.g., if the plate is dipped). The chemical treatment may be performed at room temperature or at other temperatures, such as an elevated temperature.

The shape and the configuration of the vias 64 may vary depending on the specific design of the bipolar plate 50. In some embodiments, the vias 64 may be completely enclosed by the bipolar plate itself, except for the entrance/inlet and the exit/outlet. For example, the vias 64 may be tubes or conduits, and may have substantially circular or rectangular cross-sections. In another embodiment, the vias 64 may be defined by a corrugation between two opposing sides of the bipolar plate. In this embodiment, the vias may have a generally triangular cross-section. However, other passage shapes are possible, such as oval or tapered, and the passage shape in the present disclosure is not limited. The inner surfaces of the vias 64 may be smooth on a macro-level (e.g., scale above 1 mm), or they may include macro-level bumps or other features. The macro-level features may increase the turbulence of the gas flow or direct the gas flow during operation of the fuel cell (e.g., to help improve cell pressure control). In some embodiments, the vias 64 may include enclosed tubes or conduits that are formed by two halves of the bipolar plate. In other embodiments, there may be a cover sheet or cover plate that overlies a channel or depression in the bipolar plate to form an enclosed tube or conduit.

In one embodiment, the hydrophobic treatment may be applied to the inner surface(s) of the vias 64, which may be the surface(s) that define the passage through which fluid received from the active area flows (e.g., air/fuel and generated water). The treatment may be applied to all surfaces, including any macro-level features. If the vias 64 are formed by two halves of a bipolar plate, the halves may be treated prior to assembling or combining the halves. However, if the treatment includes dipping the bipolar plate into a bath, the halves may be already assembled during treatment. If the vias 64 are at least partially formed by a cover sheet or plate, the via-side of the cover sheet/plate may be treated in a similar manner as the bipolar plate itself prior to installation. In some embodiments, the inner surfaces may be the only surfaces treated; however, in other embodiments the outer surfaces of the vias 64 may also be treated. For example, if the bipolar plate is treated by dipping it into a bath, then all surfaces of the vias 64 and other portions of the plate may be treated.

Accordingly, treated bipolar plates and methods of treating bipolar plates are disclosed. The treated portions, such as inlet or outlet vias, may be rendered hydrophobic and may reduce or prevent water build-up. By avoiding the accumulation of water in the vias, freezing and blocking of these typically small passages may be reduced or avoided. Accordingly, freeze start-up procedures may be reduced or eliminated, as well as the associated delay in being able to operate a fuel cell vehicle. The treatment may result in a surface that has a contact angle with water of at least 90 degrees, for example, at least 100, 110, 120, or 130 degrees. In some embodiments, the treatments may result in a surface that is super hydrophobic, having a contact angle with water of at least 150 degrees.

Based on the present disclosure, one of ordinary skill will understand that the same surface texturing practices may be used to produce hydrophilic surfaces on the bipolar plates. Furthermore, hydrophobic surfaces could be combined with hydrophilic surfaces to further tailor water management features on a bipolar plate. Making bipolar plate surfaces hydrophobic and/or hydrophilic through texturing to improve water management may allow for an alternative stack build orientation compared to the common build orientations (e.g., vertical). A horizontal stack build orientation incorporating the disclosed treated bipolar plates may improve in-vehicle stack packaging, reduce stack control system complexity, and/or reduce related costs. Because a hydrophobic surface sheds water easily, less pressure may need to be applied to eradicate water from a cell, thus potentially allowing the compressor size requirement of a system to be decreased. The natural characteristic of a hydrophobic surface to shed water may also allow for fuel cell stack unit cells to be stacked horizontally in a pancake scenario with only the inlet and exhaust manifold ports being vertical. The hydrophobicity of the textured surfaces would minimize the influence of gravity to hold generated water in-on-along the plate geometries and flowing gases could easily eradicate remaining water during shut down.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A fuel-cell bipolar plate, comprising:
an active region wherein a fuel-cell reaction is configured to occur; and
an inactive region configured to supply, collect, and remove fluids from the active region;
the inactive region including one or more exit vias defined by the bipolar plate and having an inner surface configured to contact fluids received from the active region, at least a portion of the inner surface having a hydrophobic textured surface.

2. The bipolar plate of claim 1, wherein substantially the entire inner surface has the hydrophobic textured surface.

3. The bipolar plate of claim 1, wherein the hydrophobic textured surface includes a plurality of cone-shaped surface features.

4. The bipolar plate of claim 3, wherein the surface features have a maximum width of less than 250 μm.

5. The bipolar plate of claim 3, wherein the surface features have a maximum width of 50 nm to 50 μm.

6. The bipolar plate of claim 1, wherein the hydrophobic textured surface has a contact angle with water of at least 100 degrees.

7. The bipolar plate of claim 1, wherein the inactive region further includes a transition region defined by the bipolar plate and disposed between the active region and the one or more exit vias, the transition region including one or more channels or features configured to transport and guide fluids from the active region to the exit vias.

8. The bipolar plate of claim 7, wherein at least a portion of the one or more channels or features in the transition region has a hydrophobic textured surface.

9. The bipolar plate of claim 8, wherein the hydrophobic textured surface includes a plurality of cone-shaped surface features having a maximum width of less than 250 μm.

10. The bipolar plate of claim 1, wherein a smallest dimension of the one or more exit vias is at most 0.50 mm.

11. A method, comprising:
treating a metal inner surface of an exit via defined in an inactive region of a fuel-cell bipolar plate that is configured to contact fluids received from an active region of the fuel-cell bipolar plate; and
the treatment including removing material to form a hydrophobic textured surface on at least a portion of the inner surface.

12. The method of claim 11, wherein the treatment forms a plurality of cone-shaped surface features.

13. The method of claim 11, wherein the treatment forms surface features having a maximum width of less than 250 μm.

14. The method of claim 13, wherein the surface features have a maximum width of 50 nm to 50 μm.

15. The method of claim 11, wherein the treating step includes removing material from the metal inner surface using a laser treatment.

16. The method of claim 11, wherein the treating step includes removing material from the metal inner surface using a chemical treatment.

17. The method of claim 11, wherein the treatment is applied to the entire inner surface of the exit via.

18. The method of claim 11, further comprising treating at least one metal channel surface of a transition region of the inactive region of the fuel-cell bipolar plate that is disposed between the exit via and the active region, the treatment forming a hydrophobic textured surface on at least a portion of the channel surface.

19. The method of claim 11, wherein the bipolar plate includes a plurality of air exit vias defined therein and the treating step includes treating a metal inner surface of each air exit via to form a hydrophobic textured surface on at least a portion of the inner surface.

20. A fuel-cell bipolar plate, comprising:
an active region;
an inactive region configured to supply, collect, and remove fluids from the active region, the inactive region including an exit via defined by the bipolar plate and having a width of at most 3.0 mm, an inner surface of the exit via configured to contact fluids received from the active region; and
at least a portion of the inner surface having a hydrophobic textured surface.
